(19) United States
(12) Patent Application Publication
(10) Pub. No.: US 2003/0167559 A1
(43) Pub. Date: Sep. 11, 2003

(54) Method and apparatus of obtaining refrigerated wearing and dressing

(76) Inventors: Hoton How, Belmont, MA (US); Yung-Ching Chu, Tao Yuan (TW)

Correspondence Address: Hoton How, 262 Clifton St., Belmont, MA, 02478, US

(21) Appl. No.: 10/092,403

(22) Filed: Mar. 7, 2002

(51) Int. Cl. A62B 17/00; A62D 5/00

(52) U.S. Cl. 2/458

(57) ABSTRACT

Disclosed is a method and two apparatuses enabling refrigerated wearing and dressing. A refrigerant substance in condensed phase undergoing sublimation or evaporation into gaseous phase will absorb heat. By convecting the sublimated or evaporated phase of the refrigerant substance onto areas surrounding a wearing or a dressing, temperatures nearby can thus be lowered, resulting in comfort on wearing or dressing. Refrigeration in this manner is effective, since sublimation heat and evaporation heat are much more pronounced than can otherwise be obtained via using a battery or a dry cell, for example. Refrigerant can be placed in a container providing convenience in use, allowing for refill or replacement when depleted. Refrigerated clothes, hats, hamlets, etc., are in great need by our communities, in situations whenever it requires walking across air-conditioned stations, working under the sun or before a furnace, driving a motorcycle with an air-tight hamlet, and so forth.

### FEDERALLY SPONSORED RESEARCH

(Not Applicable)

### SEQUENCE LISTING OR PROGRAM

(Not Applicable)

### BACKGROUND

1. Field of Invention

This invention is directed to a method and two apparatuses to obtain refrigerated wearing and dressing. In other words refrigerant is used to lower temperatures on wearing and/or on dressing so as to bring in comfort in a too-warm environment. Wearing and dressing include clothes, a vest, a garment, a cap, a hat, and a hamlet, etc.

2. Prior Art

Human has no way to avoid altogether working in a too-warm environment, even if air conditioning has been provided allover most of the places. For example, after stepping out an air-conditioned vehicle the passenger has to expose his or her body to a hot weather before entering another air-conditioned station. A civil engineer has to patrol under the sun for most of the time in a summer afternoon monitoring the construction of a building to follow exactly as pre-designed. A metallurgist has to place his or her face close to a burning furnace to watch against if a chemical reaction has gone wrong. A motorcyclist has to wear an air-tight hamlet so as to prepare against the occurrence of an accidence. In all of these situations human is still suffering, and the prior art provides no solution at all to help.

### OBJECTS AND ADVANTAGES

Accordingly, it is an object of the invention to address one or more of the foregoing disadvantages or drawbacks of the prior art, and to provide such an improved method and apparatuses to obtain refrigerated wearing and dressing. This allows the outfit of haman body to cool down in a too-warm environment, bringing comfort and piece in his or her mind, thereby rendering efficiency and joy at work and at entertainment.

Other objects will be apparent to one of ordinary skill, in light of the following disclosure, including the claims.

### SUMMARY

In one aspect, the invention provides a method which sets up refrigeration on wearing and dressing, keeping human body cool in a too-warm environment, and hence to bring in comfort and joy at work or at entertainment. Refrigeration results if refrigerant is allowed to evaporate or sublimate, with the evaporated or sublimated gas guided and circulated in a tube forming a network attached to the inside of a dressing or a wearing, carrying excessive heat away from surrounding human body, thereby maintaining the temperature in a desirable range.

In another aspect, the invention discloses an apparatus which allows refrigerated clothes to be fabricated. By evaporating or sublimating a refrigerant, cold gas is produced. Thus, by convecting the evaporated or sublimated cold gas through a network of fine tubes installed with the clothes, the temperatures local to the clothes are lowered, resulting in comfort and joy when work is required in a too-warm environment.

In another aspect, the invention discloses an apparatus which allows refrigerated head wearing, such as a hat, a cap, or a hamlet, etc., to be fabricated. By evaporating or sublimating a refrigerant, cold gas is produced. Thus, by convecting the evaporated or sublimated cold gas through a network of fine tubes installed with the head-wearing, the temperatures local to the head-wearing are lowered, resulting in comfort and joy when work is required in a too-warm environment.

### DRAWINGS

### Figures

For a more complete understanding of the nature and objectives of the present invention, reference is to be made to the following detailed description and accompanying drawings, which, though not to scale, illustrate the principles of the invention, and in which:

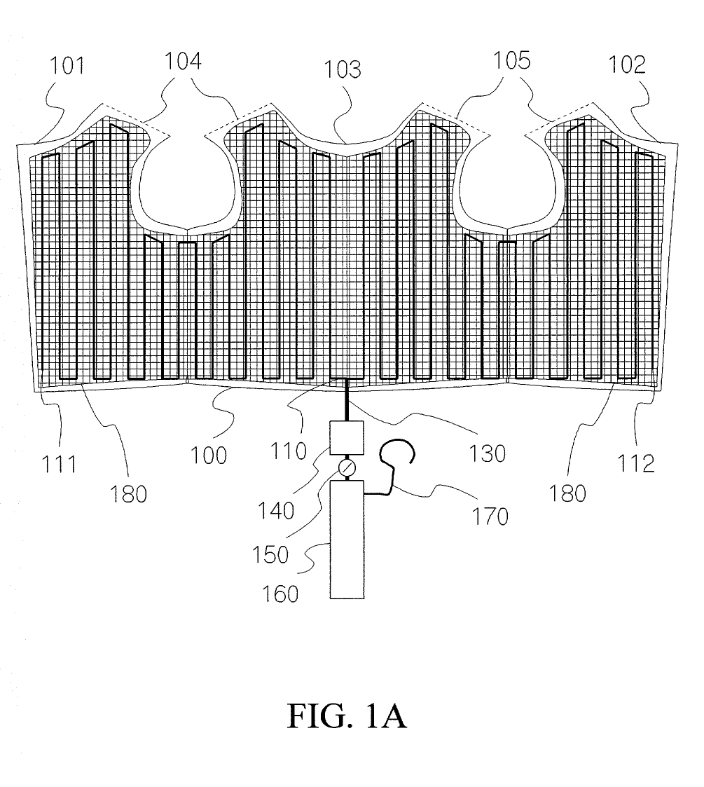

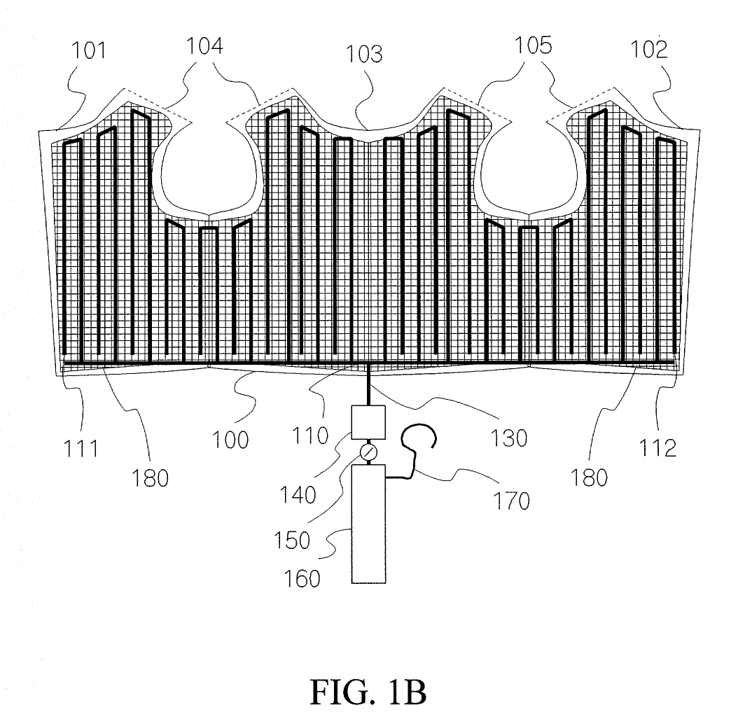

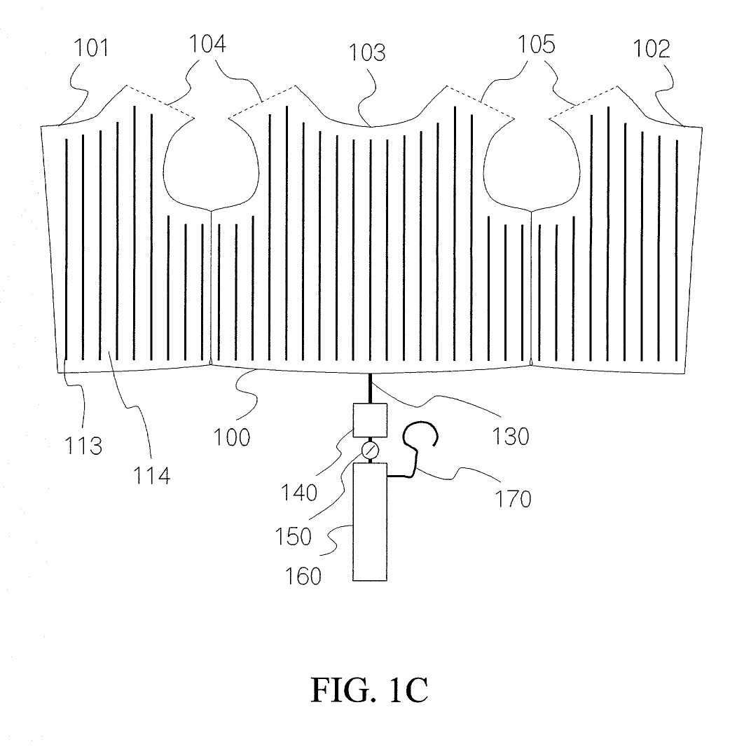

FIG. 1A shows one example of the preferred embodiment of the invention that a refrigerated vest is illustrated, showing an extended view. Refrigerant, after evaporation or sublimation, leads to gaseous phase to be conducted through a tube network attached to the vest at inside. A thin metal-wire net is also illustrated so as to make the surrounding temperature uniform.

FIG. 1B shows the same example of FIG. 1A except that Tube Network, which carries refrigerant in gaseous phase, assumes more openings. That is, FIG. 1A assume two openings at the two respective ends of Tube Network, whereas multiple openings more than 2 are illustrated in FIG. 1B.

FIG. 1C shows the same example of FIG. 1A except that Tube Network, which carries refrigerant in gaseous phase, has been integrated with the vest disclosed. That is, the vest assumes a structure consisting of connected ducts to simulate that of Tube Network. Ventilation holes are included with the vest at the inside surface to allow cold gas to come out, and hence to provide cooling on wearing.

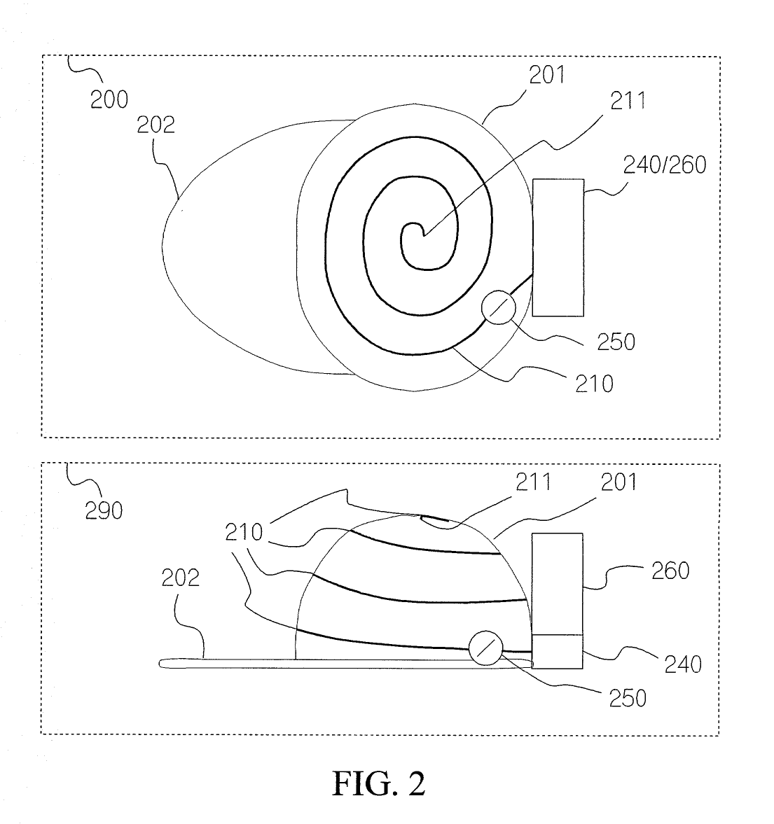

FIG. 2 shows another example of the preferred embodiment of the invention that a refrigerated hat is illustrated showing both the top view and the side view. Refrigerant, after evaporation or sublimation, leads to gaseous phase to be conducted through a tube network attached to the head at inside. The refrigerant, which is contained in a can container, together with an air pump are installed nearby in a convenient manner.

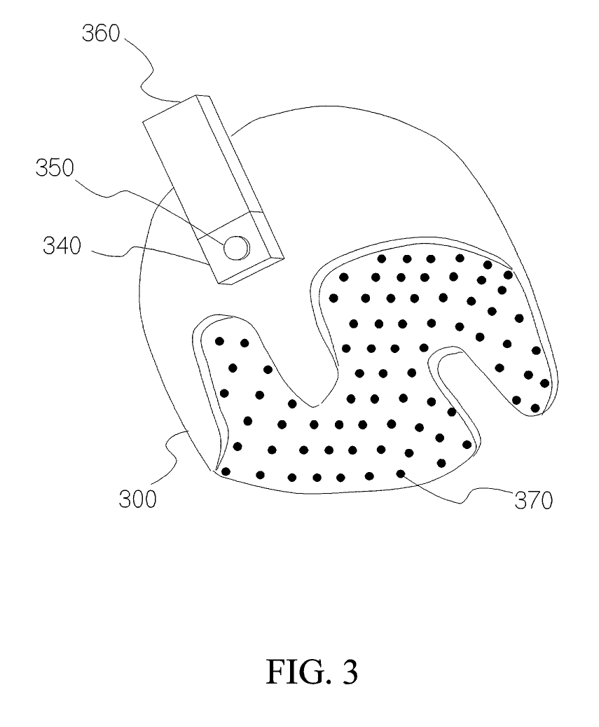

FIG. 3 shows another example of the preferred embodiment of the invention that a refrigerated hamlet is illustrated adopting a tilted view. Refrigerant, after evaporation or sublimation, leads to gaseous phase to be conveyed into the hollow structure of the hamlet. Ventilation holes are included with the inside wall of the hamlet so that cold gas can thus be vented out, resulting in cooling down of the region enclosed by the hamlet.

### REFERENCE NUMERALS

100 Extended View of Vest

101 Front-Left Piece of Vest

102 Front-Right Piece of Vest

103 Back Piece of Vest

104 Left Shoulder being cut to enable an Extended View of Vest

105 Right Shoulder being cut to enable an Extended View of Vest

110 Tube Network

111 Left End of Tube Network

112 Right End of Tube Network

113 Compartment Wall

114 Compartment/Ventilation Duct

130 Inlet Tube

140 Air Pump

150 Valve Control Knob

160 Container/Can of Refrigerant

170 Hook for Attachment

180 Thin Metal-Wire Net

200 Top View of Refrigerated Hat

201 Hat

202 Brim

210 Tube Network

211 End of Tube Network

240 Air Pump

250 Valve Control Knob

260 Container/Can of Refrigerant

290 Side View of Refrigerated Hat

300 Hamlet

340 Air Pump

350 Valve Control Knob

360 Container/Can of Refrigerant

370 Ventilation Hole

### DETAILED DESCRIPTION

Preferred Embodiment:—FIG. 1A, FIG. 1B, and FIG. 1C

FIG. 1A shows an example of the preferred embodiment of the invention that a refrigerated vest is illustrated showing an extended view. That is, Vest 100 contains three parts, Front Left 101, Front Right 102, and Back 103, and the shoulder parts of Vest 100 have been cut open to reveal an extended view. The shoulder parts are denoted in FIG. 1A as Left Shoulder 104 and Right Shoulder 105. It is also understood that when wearing Vest 100 the two edges of Front Left 101 and Front Right 102 are brought together and tie up via the use of buttons or a zipper, as assumed by a normal vest. Tube Network 110 is attached to the inner surface of Vest 100. Refrigerant is contained in Can 160, which is allowed to evaporate or sublimate if Valve Control Knob 150 is opened. Air Pump 110, powered by a battery, is used to pump, if necessary, the evaporated or sublimated gas into Inlet Tube 130 which is connected to Tube Network 110 at midpoint. The two end points of Tube Network 110 are 111 at Left End, and 112 at Right End. Refrigerant Can 160 is attached to Hook 170 which can be hooked to, for example, a waist belt for convenient carriage. Container Can 160 can be refilled or replaced, if the refrigerant depletes. Metal-Wire Net 180 is shown in FIG. 1A whose function is to make the surrounding temperature uniform when Vest 100 is wore.

It is known that a substance undergoing phase change from solid to gas or from liquid to gas absorbs heat, called sublimation heat or evaporation heat, respectively. A refrigerant can thus be any substance, so long as it assumes gaseous phase at room temperatures under 1 atmosphere pressure. To operate, the refrigerant is compressed under high pressure into a condensed phase being either a solid or a liquid to be placed in Container Can 160. When Valve 150 is opened, pressure is lowered, and the refrigerant substance will go sublimation or evaporation accordingly to return to gaseous phase accompanied by heat absorption. This results in cold gas to flow, and the flow is conducted or guided in Tube Network 110 so as to lower the temperatures nearby. To reinforce the flow of the cold gas Air Pump 140 may be installed, especially when a sublimation process is assumed by the refrigerant substance. Valve 140 can not only turn on and off the gaseous flow, but also to adjust the amount of the gaseous flow, giving rise to temperature control over the disclosed device of Refrigerated Vest, 100.

Substances preferred to be used as refrigerant for the disclosed Vest 100 shown in FIG. 1A are carbon dioxide CO₂ and nitrogen N₂, since they are environmentally safe, colorless, odorless, poisonless, and cost effective. Unlike oxygen O₂, there is no risk to cause a fire. Also, both of them are effective refrigerant used widely by the current industries. The difference between CO₂ and N₂ is: carbon dioxide will assume a sublimation process, whereas an evaporation process will be assumed by nitrogen for the required refrigeration operation.

Inlet Pipe 130 is preferred to be made of rubber, giving rise to thermal insulation and shape flexibility. Tube Network 110 assumes the geometry of a thin-wall, small-diameter tube wrapping around Vest 100 attached to the inside surface. Polyethylene material may be used, since it can be cast into thin-wall, small-diameter tube with easy exhibiting thermal semi-insulation and flexibility. To provide comfort on wearing, Vest 100 shall be flexible like a fabric. Also, Tube Network 110 shall be thermal semi-insulating, allowing the cold-gas flow conducted inside the tube to be gradually warmed up. In order to make the temperature uniform surrounding Vest 100 Metal Net 180 may be installed, spreading over the inner surface of Vest 100 making thermal contact with Tube Network 110. Thin wire-filament is preferred for Metal Net 180 so as to provide shape flexibility with Vest 100.

FIG. 1A shows two openings for Tube Network 110 located at its two ends, 111 and 112, respectively. More openings on Tube Network 110 may appear, as shown in FIG. 1B. If gas on exiting Tube Network 110 has already returned to a warm temperature, two openings suffice, as shown in FIG. 1A. However, if the exiting gas is still cold, it may be desirable to bring about more gas-exiting holes to attain a higher cooling efficiency, as shown in FIG. 1B. Gas exiting holes may locate at low positions of Tube Network 110, as shown in FIG. 1B, if a light gas such as N₂ is used as the refrigerant. For a heavy gas, such as CO₂, opening holes shall be located at high positions of Tube Network 110.

The disclosed Tube Network 110 shown in FIG. 1A may be combined with Vest 100 to form an integrated structure. This is shown in FIG. 1C. In FIG. 1C Vest 100 assumes a structure consisting of connected ducts simulating that of Tube Network 110 shown in FIG. 1A. In other words, Vest 100 of FIG. 1C includes many connected Compartments or Ventilation Ducts one of which is denoted as 114; Compartments are separated by Compartment Walls one of which is denoted as 113. To operate cold gas of refrigerant is released from Inlet Tube 130 inflating all of the compartments or ventilation ducts included with Vest 100. Ventilation holes, serving as exits for the injected cold gas, are included with the inner surface of the compartments toward human body, thereof providing cooling on wearing. The outer surface of Vest 100 is otherwise air tight. A thin-metal net, such as 180 shown in FIG. 1A, may be included with Vest 100 shown in FIG. 1C providing a mean to achieve temperature uniformity. Vest 100 may be fabricated by sealing or gluing two polyethylene sheets at the Compartment Wall positions, one with Ventilation Holes, and the other without. A piece of fabric may be attached to the outside surface of Vest 100 for aesthetic reasons. Other materials may also be considered. For example a sheet of canvas is semipermeable to air flow, which may be used as the inner surface of Vest 100 shown in FIG. 1C; another air-tight sheet, for example, leather, is then used as the outer surface of Vest 100, which is attached to the canvas sheet glued or sealed at the Compartment Wall positions.

Preferred Embodiment:—FIG. 2

FIG. 2 shows another example of the preferred embodiment of the invention that a refrigerated hat is illustrated showing both the top view, 200, and side view, 290. Refrigerant, which in contained in Can 260, is evaporated or sublimated if Valve Control Knob 250 is opened. The evaporated or sublimated gas is conducted or guided along Tube Network 210, taking exit at End 211 located at top of Head 201. Air Pump 240, powered by a battery, may be included so as to reinforce gas circulation, especially when the refrigerant assumes a sublimation process. In FIG. 2 202 denotes Brim. Air Pump/Container Can, 240/260, is attached to the rear of Hat 201 for convenient carriage. Container Can 260 can be refilled or replaced, if the refrigerant depletes.

In FIG. 2 Valve Control Knob 250 can not only turn on and off the gaseous flow in Tube Network 210, but also provide adjustment in the gaseous flow, and hence the control over the temperatures of Refrigerated Hat 201. As shown in FIG. 2 the opening hole locating at Tube Network End 211 shall point to the downward direction so as to facilitate the cooling efficiency. Tube Network 210 is attached to the inside surface of Hat 201, and Valve Control Knob 250 is located at outside. All discussions appearing in association with FIG. 1A and FIG. 1B can equally be applied here. For example, gas exiting holes more than one may be included with Tube Network 210, and a thin-metal net may be attached to the inner surface of Hat 201 making thermal contact with Tube Network 210. Carbon Dioxide or Nitrogen are preferred to be used as the refrigerant substance, and polyethylene material may be used for Tube Network 210.

Preferred Embodiment:—FIG. 3

FIG. 3 shows another example of the preferred embodiment of the invention that a refrigerated hamlet is illustrated adopting a tilted view. Although the same structure of FIG. 2 can also be applied to a hamlet, FIG. 3 shows an alternative. The difference between FIG. 2 and FIG. 3 is that Tube Network 210 is not used; instead, Ventilation Holes 370 are assumed, located on the inner surface of Hamlet 300, ejecting cold gas toward its inside. That is, in FIG. 3, refrigerant is contained in Can 360, and after sublimation or evaporation, the gaseous flow is controlled by Valve Control Knob 350, ejecting into the hollow structure assumed by Hamlet 300; cold gas vents out from Ventilation Holes 370, to keep it cool for the region enclosed by Hamlet 300. Air Pump 350 may be installed, powered by a battery, especially when a sublimation process is assumed by the refrigerant. Air Pump 340 and Container Can 360 is attached to one side (right side) of Hamlet 300 for convenient carriage. Container Can 360 can be refilled or replaced, if the refrigerant depletes. Carbon Dioxide or Nitrogen are preferred to be used as the refrigerant substance, as discussed previously with FIG. 1A and FIG. 1B.

### Conclusions

Refrigerated wearing and dressing are obtained by incorporating the convection of cold gas arising from a sublimation or an evaporation process. Since the sublimation or the evaporation heat is huge comparing to the specific heat required to rise the temperatures in air surrounding human body, cooling using a refrigerant agency is thus efficient and effective. Sublimation or evaporation heat is even more pronounced for a polarized substance, such as carbon dioxide, CO₂. Small-diameter thin-wall polyethylene tubes may be used to conduct the flow of cold gas attached to the inside surface of a dressing or a wearing. Alternatively, cold gas is ejected into the hollow structure of a wearing or a dressing to be vented out subsequently through ventilation holes without assuming the use of a tube network. For both methods flexibility can be obtained, resulting in comfort on wearing and dressing.

We claim:

1. A method of obtaining refrigerated wearing or dressing, comprising:
A) setting up a sublimation or an evaporation process using a refrigerant contained in a container,
B) inducing convection of the sublimated or evaporated gas of said refrigerant via predetermined means passing across areas local to a wearing or a dressing intended for refrigeration,
wherein by controlling the flow rate of said sublimated or evaporated gas the temperatures local to said wearing or dressing are controlled, thereby bringing in comfort on incorporating said refrigerated wearing or dressing.

2. The method of claim 1 wherein said refrigerant includes carbon dioxide or nitrogen.

3. The method of claim 1 wherein said predetermined means include employing a tube network conducting or guiding the flow of said sublimated or evaporated gas, or using ventilation holes ejecting said sublimated or evaporated gas, or both.

4. The method of claim 3 wherein said tube network includes a plurality of gas exiting holes of a predetermined number.

5. The method of claim 3 wherein said tube network assumes an integrated structure to include a plurality of connected compartments or ducts with ventilation holes at one side.

6. The method of claim 1 wherein one or a plurality of metal-wire nets are used accompanying said predetermined means in controlling said temperatures local to said wearing or dressing.

7. A refrigerated clothes device capable of lowering nearby temperatures surrounding human body on wearing, comprising:
(A) a refrigerant substance contained in a container capable of initiating a sublimation or an evaporation process when said container is opened,
(B) a predetermined mean of convecting said refrigerant substance in gas phase onto areas local to said refrigerated clothes device,
wherein, by adjusting the flow rate of said refrigerant substance in said gas phase excessive heat nearby said refrigerated clothes device surrounding said human body is removed to a desired degree, thereby bringing in comfort on wearing said refrigerated clothes device.

8. The refrigerated clothes device of claim 7 wherein said refrigerant substance includes carbon dioxide or nitrogen.

9. The refrigerated clothes device of claim 7 wherein said predetermined mean includes employing a tube network conducting or guiding the flow of said refrigerant substance in said gas phase, or using ventilation holes ejecting said refrigerant substance in said gas phase, or both.

10. The refrigerated clothes device of claim 7 wherein said tube network includes a plurality of gas exiting holes of a predetermined number.

11. The refrigerated clothes device of claim 7 wherein said tube network assumes an integrated structure to include a plurality of connected compartments or ducts with ventilation holes at one side.

12. The refrigerated clothes device of claim 7 wherein metal-wire nets are used together with said predetermined mean so as to obtain additional control over said nearby temperatures surrounding said human body on said wearing.

13. A refrigerated head-wearing device capable of lowering nearby temperatures surrounding human head on wearing, comprising:
(A) a refrigerant substance contained in a container capable of initiating a sublimation or an evaporation process when said container is opened,
(B) a predetermined mean of convecting said refrigerant substance in gas phase onto areas local to said refrigerated head-wearing device,
wherein, by adjusting the flow rate of said refrigerant substance in said gas phase excessive heat nearby said refrigerated head-wearing device surrounding said human head is removed to a desired degree, thereby bringing in comfort on wearing said refrigerated head-wearing device.

14. The refrigerated head-wearing device of claim 13 wherein said refrigerant substance includes carbon dioxide or nitrogen.

15. The refrigerated head-wearing device of claim 13 wherein said predetermined mean includes employing a tube network conducting or guiding the flow of said refrigerant substance in said gas phase, or using ventilation holes ejecting said refrigerant substance in said gas phase, or both.

16. The refrigerated head-wearing device of claim 15 wherein said tube network includes a plurality of gas exiting holes of a predetermined number.

17. The refrigerated head-wearing device of claim 15 wherein said tube network assumes an integrated structure to include a plurality of connected compartments or ducts with ventilation holes at one side.

18. The refrigerated head-wearing device of claim 13 wherein metal-wire nets are used together with said predetermined mean so as to obtain additional control over said nearby temperatures surrounding said human head on said wearing.
